(19) United States
(12) Patent Application Publication
(10) Pub. No.: US 2009/0077271 A1
(43) Pub. Date: Mar. 19, 2009

(54) AVOIDING TV MENU NEGOTIATION TO PRESET CONFIGURATION OPTIONS

(75) Inventor: Bjoern C.W. Kaag, Heerlen (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,215

(22) PCT Filed: Nov. 15, 2005
(86) PCT No.: PCT/IB05/53764

§ 371 Date: May 14, 2007

Related U.S. Application Data
(60) Provisional application No. 60/629,796, filed on Nov. 19, 2004.

(51) Int. Cl. G06F 13/12

(52) U.S. Cl. 710/10

(57) ABSTRACT

A configuration option setting system and method is disclosed making it possible for a user to quickly set the configuration options in a host device (120) (e.g., TV) which includes a pod slot interface (150) thereby freeing the user from having to learn and navigate the menu system of the host device (120). Configuration options are set in the host device (120) via a software simulation program (a PC pod simulation program) running on a personal computer (110) external to the host device (120). The PC pod simulation program simulates the functionality of a conventional POD (point of deployment or point of delivery) cable card for setting user defined configuration options. The PC pod simulation program overcomes and avoids the limitations of the prior art whereby a POD cable card could only be preset at the factory and was only changeable thereafter using the menu system of the host device (120).

The invention relates generally to a method and system of presetting configuration options in a host device. More particularly, the invention relates to presetting configuration options in a host device without having to navigate the menu system of the host device. The invention also relates to a software program for implementing the method.

As is known, a digital cable ready television set is an official term for a high definition television set that meets the plug-and-play digital cable TV standard using POD (point of deployment or point of delivery) cable cards. A cable card is a small one-way digital cable decoder that is the size of a credit card, having a PCMCIA style (similar to a laptop PC card). The cable card fits inside an expansion port built into the newer televisions. A primary function of the cable card is to enable a television (or similar device, e.g., PVR) to decode encrypted or scrambled content delivered from cable systems. Beyond performing this well known decoding function, the cable card can be preset by the cable operator with a number of configuration options, such as, for example, time-zone, daylight savings control, language and emergency alert location, to name a few.

Typically, the cable operator provides only one type of cable card to each consumer. That is, every cable subscriber receives a cable card having the same configuration option settings preset therein. This is advantageous to the cable operator by not having to configure (customize) the cable cards for each customer. Conversely, it is equally disadvantageous for the consumer in that the process of re-setting the configuration options on the delivered card from the factory settings to settings which are more preferable to the consumer's needs is oftentimes a time-consuming, complicated and inconvenient process requiring that the consumer negotiate a complex and non-intuitive menu system which is different for every brand of television set and sometimes different models of television sets within a brand. Unfortunately, despite the advances in technology, the process of negotiating such menu systems has become increasingly complicated and inconvenient and therefore, more difficult for the average consumer to negotiate.

This problem becomes especially acute in a retail setting in which salesmen are required to learn how to navigate the menu systems for a multiplicity of TV models being sold in the retail outlet. The process of having to constantly learn and retain how each menu system works is both time consuming and in some cases beyond the ability of a TV sales person to master. To the best of the inventor's knowledge, no method of easily navigating such menu systems has been provided to the consumer to date. The problem is that the process of adjusting (i.e., re-setting) the factory preset configuration options is not being presented to consumers in a user friendly manner.

What is needed therefore is a straight forward system and method to allow users to adjust or re-set configuration options in television sets, or similar device, from factory configuration settings to user preferred settings without having to learn how to navigate the cumbersome and non-intuitive menu systems of such sets.

In view of the aforementioned problems and deficiencies of the prior art, the present invention provides a configuration option setting system, method and software program for implementing the method, making it possible for a user to quickly set the configuration options in a host device, thereby freeing the user from having to learn and navigate the cumbersome and non-intuitive menu system of the host device.

According to an aspect of the present invention, a method for presetting configuration options in a host device without having to navigate a menu system of the host device comprises: inserting a PCMCIA form connector into a pod slot interface of the host device, the PCMCIA form connector having cabling permanently attached to one end; coupling a free end of the cabling to an interface of the hardware machine, hereby completing a connection between the host device and the hardware machine; and executing a software module, referred to as a PC pod simulation program, loaded into the hardware machine to automatically change at least one configuration parameter of the host device without having to navigate a menu system of the host device.

A key feature of the invention is that the software module (i.e., PC pod simulation program) simulates the functionality of a conventional POD (point of deployment or point of delivery) cable card. By simulating a conventional POD cable card, the present invention overcomes and avoids the limitations of the prior art in that a conventional POD cable card could only be preset at the factory and is only changeable thereafter using the cumbersome and non-intuitive menu system of the host device.

According to another aspect of the invention, a configuration option setting system comprises: a host device including a pod slot interface, a hardware machine including a PC interface, which can be any well known interface such as, for example, a serial RS 232 interface, USB interface, Ethernet interface or the like. The system further includes a PC pod simulation program, running on the hardware machine to simulate in software the functionality of a conventional pre-configured POD (point of deployment or point of delivery). The host device is coupled to the hardware machine via a PCMCIA form connector for insertion into the host device's pod slot interface. The PCMCIA form connector further includes cabling attached thereto for coupling to the hardware machine.

In one general aspect, the system provides an interface (e.g., GUI) for enabling a user to view and change the factory pre-set configuration parameter values to user preferred values.

In another general aspect, the host device is coupled to the hardware machine via a wireless communication link, such as WiFi, Bluetooth, 802.11a, 802.11b, 802.11g, IrDA (Infrared Data Association), or UMTS (Universal Mobile Telecommunications System) interface. In such a configuration, the PCMCIA form card inserted in the host device is coupled to the hardware machine via a wireless link.

In another general aspect, the hardware machine may be embodied as a hand held device, such as a personal digital assistant (PDA) or other mobile computing device.

Implementations of the techniques discussed above may include a method or process, an apparatus or system, or computer software on a computer-accessible medium.

The foregoing features of the present invention will become more readily apparent and may be understood by referring to the following detailed description of an illustrative embodiment of the present invention, taken in conjunction with the accompanying drawings, where

FIG. 1 is an illustration of a configuration option setting system of the invention in accordance with an embodiment of the present invention;

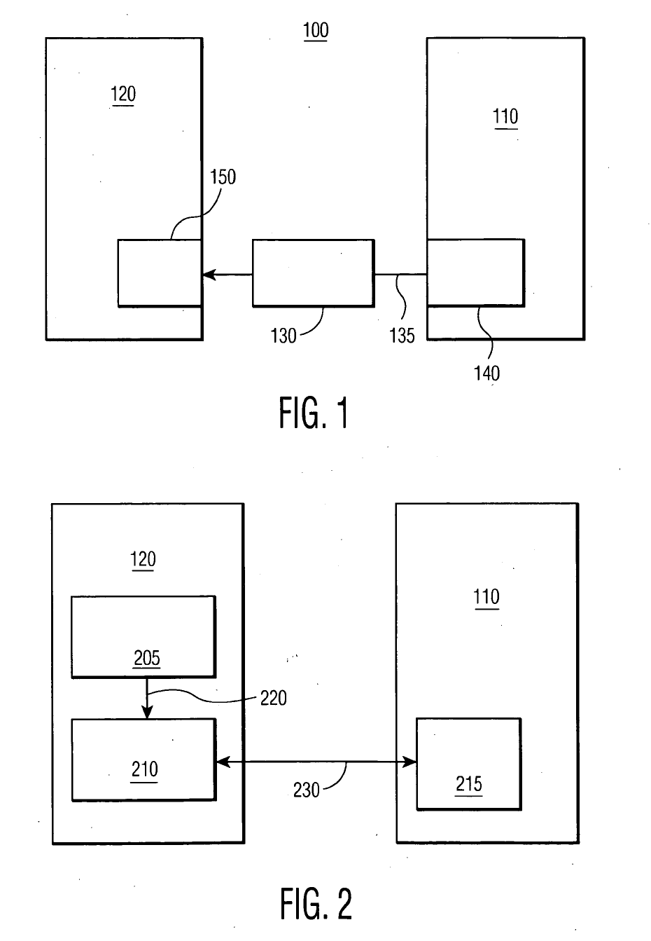

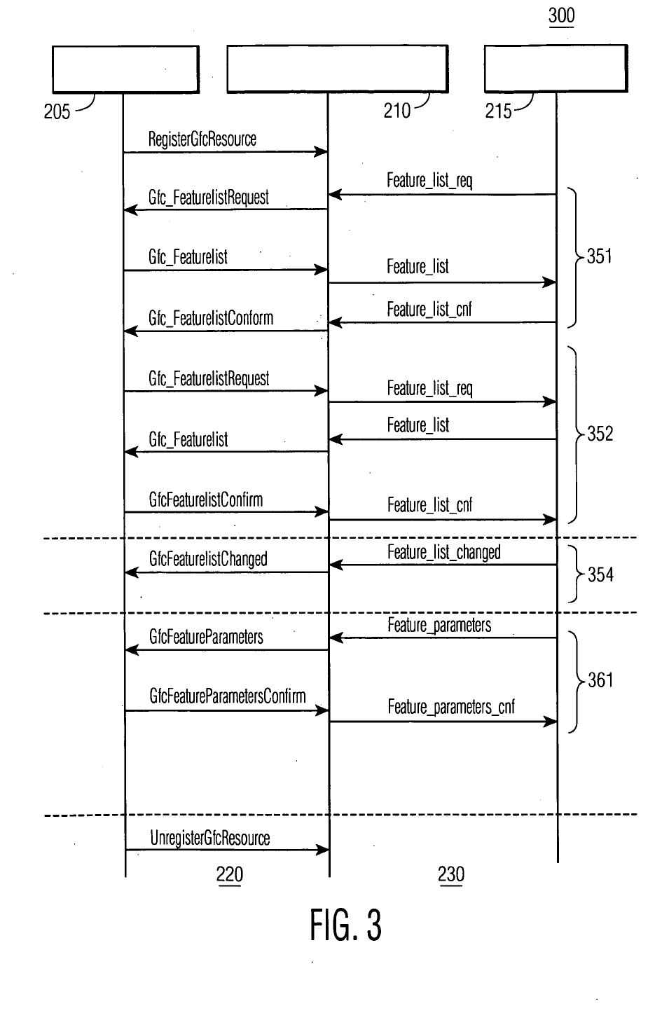

FIG. 2 is a block schematic representation of the three main software modules which are used with an embodiment of the invention;

FIG. 3 is a sequence diagram that describes the messaging transmitted between a host device and a personal computer; and

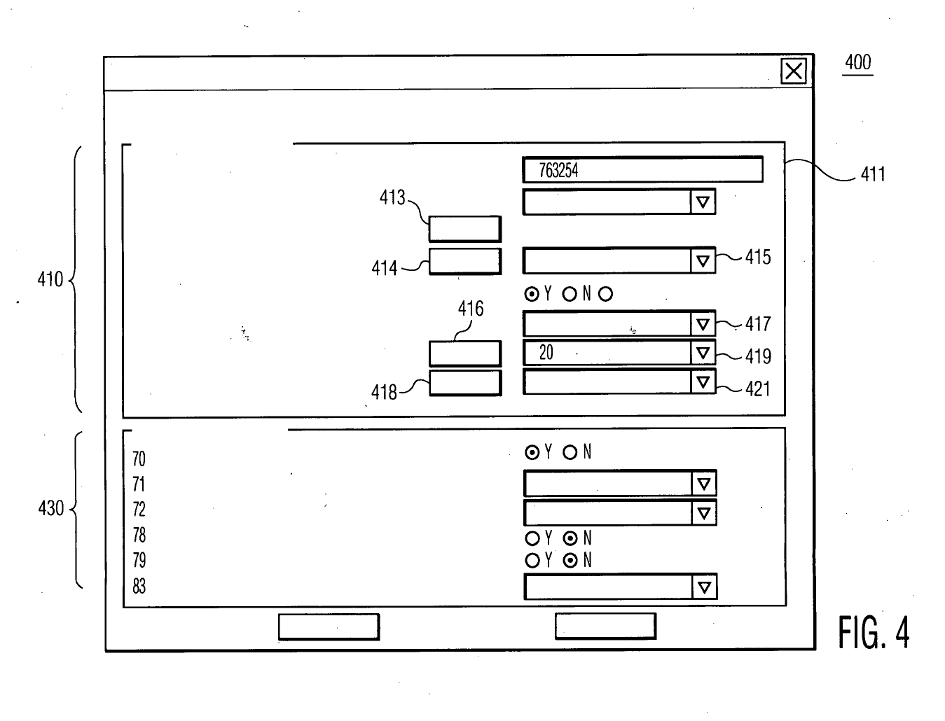

FIG. 4 is an exemplary display image window of one embodiment of a GUI screen that is shown to a user to enable the setting of configuration parameter values.

Although the following detailed description contains many specifics for the purpose of illustration, one of ordinary skill in the art will appreciate that many variations and alterations to the following description are within the scope of the invention. Accordingly, the following preferred embodiment of the invention is set forth without any loss of generality to, and without imposing limitations upon, the claimed invention

The present invention may be described, in various embodiments, as a system, method and computer readable medium for allowing a user to quickly set the configuration options in a host device such as a television set without having to navigate the menu system of the host device.

Advantageously, the invention provides a broadly flexible, powerful, and simple technique that obviates the need to learn the oftentimes convoluted and non-intuitive menu systems that are used to set configuration options in present day host devices, such as, for example, televisions (TVs), programmable video recorders (PVRs), video recorders (VCRs), convergence PC, PC/TV, set top boxes (STBs) and the like.

Referring initially to FIG. 1, a configuration option setting system 100 is illustrated in accordance with an embodiment of the present invention. The system 100 includes a host device embodied as a television set 120. As noted above, the host device can also be, for example, a programmable video recorder (PVR), a video recorder (VCR), a convergence PC, a PC/TV, a set top box (STBs) or any other existing or future device having similar functionality. The television set 120 includes a POD slot interface 150.

The system 100 also includes a hardware machine embodied as a personal computer 110 having an operating system (not shown) and typically one or more user applications (not shown) running thereon. The personal computer 110 may be any suitable type known to the art, such as an Intel-architecture (e.g., Pentium) machine, a RISC machine, or an Apple Macintosh. Further, while referred to herein as a “hardware machine”, the hardware machine may be a logical partition or a virtual machine of an underlying host machine (not shown). The operating system may be any suitable type having a command shell, such as a UNIX-based operating system with a UNIX command shell or a Microsoft Windows operating system with a MS-DOS prompt. The personal computer 110 further includes a PC interface 140 which can be any well known interface such as, for example, a serial RS 232 interface, USB interface, Ethernet interface or the like.

One of the software modules running on the personal computer 110 is referred to herein as a PC pod simulator module (not shown). The PC pod simulator module simulates in software the functionality of a conventional pre-configured POD (point of deployment or point of delivery). The PC pod simulator module sets the configuration options in the host device, e.g., television set 120, thereby obviating the need for a user to learn the navigation menu of the television set 120.

System 100 further includes a PCMCIA form connector 130 with associated cabling 135 for connecting the personal computer 110 to the television set 120. In use, PCMCIA form connector 130 is inserted into a pod slot interface 150 of the television set 120.

The inventor has recognized that pod slot interfaces are becoming increasingly common in host devices making applicability of the invention increasingly universal. It should be appreciated that even though the PCMCIA form connector 130 is constructed in accordance with a conventional pre-configured POD cable card, the PCMCIA form connector 130 does not include any of the functionality of a conventional cable card for setting configuration options in the television set 120 and serves a single purpose of coupling the television set 120 to the personal computer 110. In accordance with the principles of the invention, configuration option parameters are not changed through the PCMCIA form connector 130, as is conventional, but are instead changed under control of the PC pod simulator module.

In accordance with the exemplary system configuration shown in FIG. 1, setting up the configuration option setting system 100 is performed in accordance with the following steps. As a first step, the personal computer 110 is mated to the television set 120 using the PCMCIA form connector 130 and its associated cabling 135. One end of the cabling 135 is mated to the PC interface 140 of the personal computer 110 and the other end of the cable 135 is permanently attached to the PCMCIA form connector 130. The user inserts the PCMCIA form connector 130 into the pod slot interface 150 of the television set 120 to complete the connection.

FIG. 2 is a block diagram of the three main software modules which are used with embodiments of the invention. These main software modules include a TV set middleware module 205, a GFC resource 210 and the PC pod simulator 215. It is to be understood that the software module of the PC pod simulator 215 may be implemented in any desired computer language, and could be developed by one of ordinary skill in the computer and/or programming arts based on the functional description contained herein. It should also be understood that the PC pod simulator 215 may be implemented in software, firmware, and/or hardware or a combination thereof. In the preferred embodiment(s), the PC pod simulator 215 is implemented in software that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present invention includes embodying the functionality of the preferred embodiments of the present invention in logic embodied in hardware or software-configured mediums.

The TV set middleware module 205 is a proprietary software system implemented on arbitrary hardware, software and software architecture that implements the functional behavior of the TV set. This functional behavior can implement things such as, for example, powering up and powering down the TV set, changing the channels, displaying menus and changing options. The TV set middleware 205 is able to communicate to the outside world via the standardized interfaces of the 210 “GFC resource” module. The 205 module is connected to the 210 module via a layer of dispatch code 220, which is unnoticeable from the outside.

The GFC resource module 210 is a software module that performs the proper translations so that the TV set middleware module 205 can communicate with the PC pod simulator module 215 in accordance with the GFC protocol as defined in “HOST-POD Interface Specification”, SCTE 28/2003, revision 2003, provided by the Society of Cable Telecommunications Engineers, Inc and future versions and variations of SCTE 28. The subject matter disclosed in Document No. SCTE 28/2003 is hereby incorporated herein by reference in its entirety.

As specified in Document No. SCTE 28, the Generic Feature Control resource enables a host device (e.g., set-top terminal, television, VCR, etc.) to receive control of features which are considered generic to host devices. In other words, every host device is required to set generic features like time-zone and parental control. SCTE 28 defines a standardized interface to access these generic features.

The PC pod simulator module 215 controls the process of issuing configuration commands to the television set 120 to set its configuration parameters.

Messaging commands and requests are issued between the various software modules described above in accordance with the GFC protocol. The specific commands are referred to as APDUs in accordance with SCTE 28. Table I is a list of those APDUs defined in Document No. SCTE 28. The use of these commands will become more apparent with respect to the sequence diagram of FIG. 3.

TABLE I
Generic Feature Control Objects

| | Tag value | | Direction |
|---|---|---|---|
| Apdu_tag | (hex) | Resource | Host ←> Pod |
| Feature_list_req | 9F 98 02 | Generic | ←> |
| | | Feature Control | |
| Feature_list | 9F 98 03 | Generic | ←> |
| | | Feature Control | |
| Feature_list_cnf | 9F 98 04 | Generic | ←> |
| | | Feature Control | |
| Feature_list_changed | 9F 98 05 | Generic | ←> |
| | | Feature Control | |
| Feature_parameters_req | 9F 98 06 | Generic | ← |
| | | Feature Control | |
| Feature_parameters | 9F 98 07 | Generic | ←> |
| | | Feature Control | |
| Feature_parameters_cnf | 9F 98 08 | Generic | ←> |
| | | Feature Control | |

In operation, assuming that the appropriate hardware connections have been made, as described above, the user runs (instantiates) the PC pod simulator 215.

In operation, the user runs the PC pod simulator 215 on the personal computer 120 preferably using a GUI which displays the available configuration options in the television set 120. The GUI provides input means for allowing the user to select parameter values for setting one or more of the available configuration options in the television set 120.

Turning now to FIG. 3, a sequence diagram is shown that describes in detail the messaging that occurs between the PC pod simulator module 215 located in the personal computer 110 and the TV set middleware module 205/GFC resource module 210 located in the television set 120.

The sequence diagram 300 is composed of two lanes of messaging traffic. A first lane of traffic, generally labeled 230, illustrates commands that occur between the PC pod simulator 215 and the GFC resource module 210. This traffic lane will transmit commands bi-laterally as standardized GFC compatible APDU messages in accordance with SCTE 28 (see Table I above). A second lane of traffic, generally labeled 220, illustrates commands that occur between the GFC resource module 210 and the TV set middleware module 205. This traffic lane will transmit commands as proprietary sample dispatch code.

With reference to the sequence diagram 300, there is shown a number of regions or sections labeled 351, 352, 354 and 360, respectively. Each section of the sequence diagram 300 is generally described as follows.

At section 351:
the PC pod simulator 215 queries the TV set middleware 205 to determine what kind of features are supported by the TV set 120.

At section 352
The TV set middleware 205 queries the PC pod simulator 215 to determine what kind of features are supported by the PC pod simulator 215.

At the completion of sections 351 and 352, both the TV set middleware 205 and the PC pod simulator 215 are aware of what configuration options each side supports. It should be noted that the term ‘configuration options’ are also referred to as ‘features’ in the context of GFC.

In the case where it is determined in accordance with section 351 that the TV set 120 does not support any features, then there is no point in the PC pod simulator 215 attempting to change features in the TV set 120. However, if it found that there is commonality between the features supported by each device then any of the features found to be in common may be changed by the PC pod simulator 215.

Table II is a list of all of the features (configuration options) and their assigned feature ID that may be supported by a host device such as television set 120 in accordance with SCTE 28. It is noted, however, that in accordance with SCTE 28, it is not mandatory that a host device such as the television set 120, support any of the features illustrated in Table II. However, it is mandatory that every host device at least support the GFC resource.

TABLE II
Generic Feature IDs

| Feature ID | Feature |
|---|---|
| 00 | Reserved |
| 01 | RF Output Channel |
| 02 | Parental Control PIN |
| 03 | Parental Control Settings |
| 04 | IPPV PIN |
| 05 | Time Zone |
| 06 | Daylight Savings Control |
| 07 | AC Outlet |
| 08 | Language |
| 09 | Rating Region |
| 0A | Reset Pin |
| 0B | Cable URLs |
| 0C | Emergency Alert Location Code |
| 0D-3F | Reserved for future use |
| 70-FF | Reserved for proprietary use |

Referring to Table II, it is noted that there are currently 12 generic features (01 through 0C) defined by SCTE 28 which may be configured in a host device such as television set 120 and 128 (70-FF) proprietary features which are set aside as manufacturer specific features. As such, a manufacturer has the option to define any brand specific feature of his choosing and assigning it a feature identifier in the range (70-FF). Proprietary features may include, for example, presetting preferences for color schemes (vibrant reds, natural flesh, eco green or the like), preferences for audio settings (movie, music, speech, classic), presetting options like automatic acceptation of software download from network, auto-start applications from network (in case of OCAP), enabling subtitling for the hearing impaired, setting the language of the TV set's dialogs, etc.

By way of example, assume a user wishes to change certain features (i.e., configuration options) within the television set 120 of FIG. 1. The user would first make the appropriate hardware connections described above and illustrated in FIG. 1. Next, the user would execute the PC pod simulator 215 software module stored in the personal computer 110. Upon executing the PC pod simulator 215 software module, commands are transmitted between the two coupled devices as illustrated in accordance with one embodiment in the sequence diagram 300 of FIG. 3.

Referring again to section 351 of the sequence diagram 300 of FIG. 3, the PC pod simulator 215 queries the TV set middleware 205 to learn what kind of features are supported by the TV set 120. The TV set middleware 205 could respond, for example, by indicating that it supports the following features, whose associated feature IDs are as follows:

{01, 03, 05, 06, 71, 72, 73, 82, 83, 90, 94, AA, AB, AE, B1, B5, BC, DD, DF, EA, EB, ED, FA, FC, FF}. (1)

Then, in accordance with section 352 of the sequence diagram, when the TV set middleware 205 queries the PC pod simulator 215 to find out what kind of features are supported by the PC pod simulator 215, the PC pod simulator 215 could respond, for example by indicating that it supports the following features whose associated feature IDs are as follows:

{01, 02, 03, 04, 07, 09, 73, 81, 82, 83, 85, 86, 88, AA, AB, AC, AD, BC, BF, DF, EA, ED, FC} (2)

Using the information derived from sections 351 and 352, the PC pod simulator 215 then determines the commonality or intersection between the features supported by each of the devices. In the instant example, it would include those features common to (1) and (2), written here as:

{01, 03, 73, 82, 83, AA, AB, BC, DF, EA, ED, FC} (3)

At section 354
In the event that changes have been made to features supported by the TV set middleware 205, for example via a cable network, those changes are transmitted to the PC pod simulator 215.

At section 360
An exchange of parameter values takes place between the TV set middleware 205 and the PC pod simulator 215.

A user can execute or instantiate the PC pod simulator 215 software module resident in a memory of the personal computer in a number of different ways. In the simplest embodiment, a simple command line may be invoked from a display screen of the personal computer 110 as follows:

H:\>configuretv-v options.1^{st}
Successfully transferred 4 options to TV

In another embodiment, the PC pod simulator 215 may use a GUI screen 400. The GUI, may be generated by a display module running on the personal computer 110.

FIG. 4 is an exemplary display image window of one embodiment of a GUI screen 400 generated by the display module, that is shown to a user to enable the setting of feature values.

FIG. 4 is generally divided into two regions, a first region, labeled “Standardized options” 410 and a second region labeled “Proprietary options” 430. It should be appreciated that many other embodiments other than the one shown in FIG. 4 may be used to facilitate the setting of feature values. FIG. 4 represents just one exemplary embodiment for the purpose of illustrating how a user friendly GUI interface 400 facilitates the entry and editing of feature values.

Referring first to the standardized options 410 region of the GUI interface 400 of FIG. 4, there is shown seven features and their associated feature IDs, such as Parental Control PIN” (02) and “Emergy Alert Location Code” (0C). These (Feature, Feature ID) pairs correspond to the (Feature, Feature ID) pairs shown in table II above with the exception of the last row of Table II which defines a range of feature IDs reserved for proprietary features, as described below. The seven features are arbitrarily selected, for the purpose of explanation, as generic features supported in the television set 120. The feature values of Table II not supported in the television set 120 include {01, 04, 07, 10, 0A and 0B}.

Each of the supported features have a corresponding default feature value. For example, the Parental Control PIN feature (02) has a default value of “763254”. Default feature values may be saved by saving the screen data at the end of each session. The saved data could then be recalled in a subsequent session from a data repository associated with the personal computer 110. When the next session is initiated, the default values are retrieved from the data repository and displayed on the GUI interface 400 as shown.

Referring again to the standardized options regions 410 of FIG. 4, each of the features are described in greater detail. First, the “Parental Control Pin” (02) feature and the “Parental Control Settings” (03) features are features directed to preventing access to programs or channels that the user desires to block unless a special access code or personal identification number (PIN) is entered. In the instant example, the PIN number entered by the user in the text entry box 411 as “763254”. Once a television channel and/or program is restricted, it can only be viewed by entering the parental control PIN (02) on the television set 120. The programs or channels that the user desires to restrict are entered using the select button 413. In response to pressing the select button 413, the user is shown an electronic program guide from which the user may select the channels or programs that the user desires to block.

Next, the “Daylight Savings Control” (06) feature gives the user the ability to select, reject, or ignore daylight savings.

Next, the “Language” (08) feature is shown. Its value is obtained by clicking on the drop down menu 417. In response, the user would be shown a list of valid languages in accordance with ISO-369. The user may then select a desired language that is available on the network from the drop down list.

The remaining features in region 410 are related in the sense that they are all geographically bound to the user's current geographical location. These features include the ‘Time Zone’ feature (05), the ‘Rating Region’ feature (09), and the ‘Emergency Alert Location Code’ feature 0C).

Assume that a user wishes to input a feature value for ‘Time Zone’ (05). To do so, a user would depress the locate button 414 associated with ‘Time Zone’ (05). In response, the user would be shown a map on a pop-up display (not shown). The user clicks on the area of the map corresponding to the user's time-zone. In response, the appropriate time zone value is retrieved using a table look-up. The returned value is then inserted into entry box 415. In the exemplary GUI screen 400 of FIG. 4, the time-zone feature value retrieved from a table look-up is shown in entry box 415 as ‘PDT [GMT-7]’.

Assume that a user also wishes to input a feature value for ‘Rating Region (09). To do so, a user would depress the locate button 416 associated with the ‘Rating Region (09) feature. Similar to that described above, the user is shown a map on a pop-up display. The user clicks on the area of the map corresponding to the user's Rating Region. In response, the appropriate Rating Region value is retrieved using a table look-up. The returned value is then inserted into text box 419. In the exemplary GUI screen 400 of FIG. 4, the Rating Region feature value retrieved from a table look-up is shown in text box 419 as ‘20’.

Assume that a user also wishes to input a feature value for the ‘Emergy Alert Location Code’ (0C) feature. To do so, a user would depress the locate button 418 associated with the ‘Emergy Alert Location Code’ (0C) feature. In response, the user is shown a pop-up window requesting that the user enter the user's state, county and county sub-division if applicable. Using the geographical input information provided by the user, a table look-up is performed utilizing a database storing such information in accordance with SCTE-18 which describes emergency locations. The result of the table look-up would return the user's emergency/alert location code in text entry box 421. In the instant example, text entry box 415 shows “WA, pacific northwest”.

In one embodiment, because the ‘Time Zone’ (05) feature, ‘Rating Region’ (09) feature, and the ‘Emergency Alert Location Code’ (0C) feature are geographically bound, all three values could be obtained in a single operation. Specifically, a user would input a feature value for ‘Time Zone’ (05) as described above. Upon depressing the locate button 414 associated with ‘Time Zone’ (05), the user is shown a map on a pop-up display in response (not shown). The user clicks on the area of the map corresponding to the user's time-zone. In response, the appropriate time zone value, Rating Region value and ‘Emergency Alert Location Code’ value and are simultaneously retrieved using appropriate table look-ups, as described above.

Referring now to the second region 430 of the GUI screen 400 of FIG. 4, there is shown a number of features such as “subtitling for the hearing impaired” (70) and “Color preferences” (71). The features in this region 420 are manufacturer specific features with feature IDs in the range 70-FF (as shown in the last row of Table II). The range 70-FF, is available to each manufacturer to specify features specific to the manufacturer's brand or model.

At the bottom of the GUI screen 400 there is shown two buttons, namely, “Read from TV” and “write to TV”. The “Read from TV” button is used to retrieve the feature values that are in current use by the TV set 120. The “Write to TV” button is used to transmit updated feature values to the TV set 120.

In other embodiments, different set up configurations may be used instead of the configuration illustrated in FIG. 1. Each will be described as follows.

In one embodiment, the PCMCIA card is inserted into the PC, whereupon the user preferred feature values are transferred to the card. Upon completion, the PCMCIA card is taken to the TV 120 for insertion where after the card configures the TV 120. The PCMCIA card requires a processor in this embodiment.

In another embodiment, in lieu of a PC 110, a hand held terminal is used which could be, for example, a Palm PC, a pocket PC or a proprietary box with a PCMCIA interface. The PCMCIA card is inserted into the hand held terminal and as described above, Upon completion, the PCMCIA card is taken to the TV 120 for insertion. The PCMCIA card requires a processor in this embodiment.

In another embodiment, similar to the configuration illustrated in FIG. 1, however, the hand held terminal substitutes for the PC.

Although this invention has been described with reference to particular embodiments, it should be appreciated that many variations can be resorted to without departing from the spirit and scope of this invention as set forth in the appended claims. The specification and drawings are accordingly to be regarded in an illustrative manner and are not intended to limit the scope of the appended claims.

What is claimed is:

1. A method for presetting configuration options in a host device (120) without having to navigate a menu system of the host device (120), the method comprising the acts of:
inserting a PCMCIA form connector (130) into a pod slot interface (150) of the host device (120);
coupling the PCMICIA form connector (130) to an external hardware machine (110) having a software module loaded thereon; and
executing the software module loaded in the hardware machine (110) to automatically change the at least one configuration parameter of the host device (120) via said PCMCIA form connector inserted in said host device (120), without having to navigate the menu system of the host device (120).

2. The method of claim 1, wherein said act of coupling the PCMICIA form connector (130) to the external hardware machine (110) is a wireless coupling.

3. The method of claim 1, wherein said act of coupling the PCMICIA form connector (130) to the external hardware machine (110) is a wired coupling.

4. The method of claim 3, wherein said wired coupling further comprises attaching a cable (135) between the PCMCIA form connector (130) and an interface of the external hardware machine (110).

5. The method of claim 4, wherein the interface (140) of the personal computer (PC) (110) comprises one of a serial RS 232 interface, a USB interface, an Ethernet interface or the like.

6. The method of claim 1, wherein the host device (120) is one of a television (TV), programmable video recorder (PVR), video recorder (VCR), convergence PC, PC/TV, and Set Top Box (STB).

7. The method of claim 1, wherein the external hardware machine (110) is a personal computer (PC).

8. The method of claim 1, wherein the external hardware machine (110) is a mobile computing device.

9. The method of claim 1, wherein the software module is a PC pod simulation module for simulating the functionality of a point of deployment (POD) device associated with setting configuration options in said host device (120).

10. The method of claim 1, wherein the act of executing the PC pod simulation program comprises the invocation of commands transmitted bi-laterally between the hardware machine (110) and the host device (120).

11. The method of claim 10, wherein the commands are transmitted in accordance with the generic feature control (GFC) protocol.

12. A system for presetting configuration options in a host device (120) without having to navigate a menu system of the host device (120), comprising:
a host device (120) including a pod slot interface (150);
a PCMCIA form connector (130) configured for insertion into the pod slot interface (150) of the host device (120);
a hardware machine (110);
a software module loaded on the hardware machine (110), said software module configured to change at least one configuration parameter of the hardware machine (110).

13. The system of claim 12, further comprising cabling (135) for attaching one end of the PCMCIA form factor to an interface (140) of the hardware machine (110).

14. The method of claim 13, wherein the interface (140) of the personal computer (PC) (110) comprises one of a serial RS 232 interface, a USB interface, an Ethernet interface or the like.

15. The system of claim 12, wherein the host device (120) is one of a television (TV), programmable video recorder (PVR), video recorder (VCR), convergence PC, PC/TV, and Set Top Box (STB).

16. The system of claim 13, wherein the external hardware machine (110) is a personal computer (PC).

17. The method of claim 13, wherein the external hardware machine (110) is a mobile computing device.

18. The method of claim 13, wherein the software module is a PC pod simulation program that simulates the functionality of a point of deployment (POD) device associated with setting configuration options in said host device (120).

19. A computer readable medium storing a computer program comprising: computer readable code for automatically changing at least one configuration parameter of a host device (120) without having to navigate a menu system of the host device (120).
